(19) United States
(12) Patent Application Publication
(10) Pub. No.: US 2001/0048573 A1
(43) Pub. Date: Dec. 6, 2001

(54) Magnetic head device and method of manufacturing same

(75) Inventors: Mitsuyoshi Kawai, Tokyo (JP); Ichiro Yagi, Tokyo (JP)

Correspondence Address: OLIFF & BERRIDGE, PLC, P.O. Box 19928, Alexandria, VA, 22320, US

(73) Assignee: TDK Corporation

(21) Appl. No.: 09/842,706

(22) Filed: Apr. 27, 2001

Related U.S. Application Data
(63) Continuation-in-part of application No. 09/210,771, filed on Dec. 14, 1998.

(30) Foreign Application Priority Data
Dec. 17, 1997 (JP) 9-347678

(51) Int. Cl. G11B 5/60

(52) U.S. Cl. 360/234.5

(57) ABSTRACT

A magnetic head device and a method of manufacturing the same are provided for improving the yield of flying performance of the slider and simplifying manufacturing steps so as to reduce lead time. A magnetic head slider is bonded to a flexure forming a slider supporter with an anisotropic conductive resin having a liquid form or a highly viscous form. As a result, the slider is fixed to the flexure and at the same time, signal electrodes of the slider are thereby each electrically connected to signal electrodes of the flexure, respectively. Furthermore, a ground electrode provided in the reverse (rear) portion of a magnetic head element of the slider is connected to a ground electrode of the flexure as well.

### BACKGROUND OF THE INVENTION

1. Field of the Invention

The present invention relates to a magnetic head device used in a magnetic disk apparatus and an magneto-optic disk apparatus and a method of manufacturing such a magnetic head device.

2. Description of the Related Art

A magnetic head device in general comprises a magnetic head slider, where a magnetic head element is formed, supported by a slider supporter (suspension). The magnetic head device performs data reproduction or recording on a recording disk such as a magnetic disk, with the magnetic head slider being flown by a specific distance from the recording disk by means of the suspension.

Such a flying-type magnetic head device of related art is assembled such that a magnetic head slider is bonded on a suspension with a resin adhesive and bonding pads of the slider and bonding pads of the suspension are connected to one another through ball bonding using gold (Au), for example. In such a magnetic head device in a practical use, static electricity is generated due to the friction between the flying surface of the slider and the disk surface and due to the fact that the flying height of the slider is very small. The thin-film magnetic head element may be damaged. Measures are taken to prevent such static damage. However, usual magnetic head devices have problems as follows due to electrical connection through ball bonding and measures against static electricity. The problems will be specifically described, referring to FIG. 15 and FIG. 16.

FIG. 15 illustrates a specific configuration of a related-art magnetic head device. FIG. 16 is a cross section taken along line XV-XV of FIG. 15. FIG. 16 illustrates the magnetic head device in use wherein a medium is shown in the lower part of the drawing, which is an upside-down view of FIG. 15. The magnetic head device 100 comprises a magnetic head slider 101 and a suspension 102 for supporting the slider 101. The suspension 102 is made up of a flexure (an elastic supporter) 102A and a load beam (a rigid supporter) 102B.

A magnetic head element (an MR element, for example) 104 and bonding pads 105a to 105d for signals are formed on a side (element formed surface) 101a of the slider 101.

The flexure 102A forming the suspension 102 is made of a thin stainless steel plate of about 25 μm in thickness and fixed to the front part of the load beam 102B. The flexure 102A performs a gimbal operation together with the slider 101. Four lead patterns 106a to 106d made of thin films as input/output signal lines are formed on the flexure 102A along nearly the entire length thereof. Ends of the lead patterns 106a to 106d are each connected to four bonding pads 107a to 107d, respectively. The other ends of the lead patterns 106a to 106d are each connected to terminals (not shown) of thin films for providing connection to an external circuit. The bonding pads 107a to 107d are fixed to and electrically connected to the bonding pads 105a to 105d of the slider 101.

The load beam 102B is made of a stainless steel plate as thick as about 62 to 76 μm. The flexure 102A is fixed to the load beam 102B at a plurality of welding spots (such as a spot 108) through laser welding, for example. The load beam 102B has a projection 109 for pressing the back of the slider 101 at a point. The projection 109 comes to contact with the flexure 102A in intimate contact with the back of the slider 101 and controls backward movements of the flexure 102A. A conductive resin 110 such as silver paste is applied between the flexure 102A and a rear side 101b of the slider 101, as shown in FIG. 16, so that the flexure 102A and the slider 101 are electrically connected. The base of the flexure 102A is electrically connected to an enclosure of a disk drive apparatus not shown and grounded through the enclosure. Static electricity generated in the slider 101 is thereby allowed to escape from the back of the slider 101 through the flexure 102A to the grounded enclosure of the disk drive apparatus.

The magnetic head device 100 is manufactured through the steps including: (1) the step of bonding the slider 101 on the flexure 102A of the suspension 102 with a resin adhesive; (2) the step of connecting the bonding pads 105a to 105d of the slider 101 to the bonding pads 107a to 107d of the flexure 102A through gold (Au) ball bonding; (3) the step of applying an ultraviolet curing resin (UV resin) 111 for protecting the ball bonding portions; (4) the step of applying the conductive resin 110 as measures against static electricity; and (5) the step of applying ultraviolet rays to the ultraviolet curing resin 111 to heat.

As thus described, the manufacturing of the related-art magnetic head device requires measures against static electricity. The step of applying the conductive resin between the rear part of the slider and the suspension is therefore required in addition to the bonding step of the slider and the connection step through gold ball bonding. As a result, the lead time is increased and costs are raised as well since gold wires are used in the bonding step. Furthermore, since the device is fabricated through a number of steps described above, the device may be damaged due to static electricity during handling. In the ball bonding step, in particular, the suspension is deformed with a load applied thereto if a pressure greater than a specific pressure is applied for connection with gold balls. Such a deformed suspension affects the flying performance of the slider and causes a reduction in yields.

A flexible shield wire board is disclosed in Japanese Patent Application Laid-open Sho 63-226999 (1988). The flexible shield wire board is formed such that an anisotropic conductive sheet is thermally fused and fixed to an insulating substrate where electrode terminals are formed and the sheet is electrically connected to the terminals of the substrate. If the anisotropic conductive sheet is used, no ball bonding step could be required. However, it is very difficult in practice to electrically connect the slider to the suspension through the anisotropic conductive sheet since the size of the slider is as minute as 1.0 mm by 1.2 mm.

A technique is disclosed in Japanese Patent Application Laid-open Hei 9-115125 (1997) for bonding a magnetic head to a suspension with a film-shaped anisotropic conductive sheet to eliminate the wire bonding step and prevent shorting of terminals.

However, the method using such an anisotropic conductive film requires a high-precision alignment technique for connecting the magnetic head to the suspension through fixing the anisotropic conductive film. Further, the use of this film-type resin requires pre-processing, such as precision cutting of the film, so that the film shape matches the portions to be bonded together. In addition, the method requires the two steps of preliminary bonding and final bonding. It is therefore difficult to reduce the lead time.

Additionally, because the anisotropic conductive film can become soft or liquid upon heating, its thickness becomes unstable under pressure and the thickness of the anisotropic conductive film can vary. The varying thickness of the anisotropic conductive film can result in the positions of the suspension and a head along the uneven thickness to become misaligned. Further, the position of the suspension and the slider can tend to become misaligned. Such misalignment can be an obstacle to assembling the magnetic head device with high precision. Because the relationship of position between the head and the suspension varies greatly, the performance of the head varies as well, for example the head's output amount becomes more variable.

### SUMMARY OF THE INVENTION

It is an object of the invention to provide a magnetic head device and a method of manufacturing the same for improving the yield of flying performance of a magnetic head slider, simplifying manufacturing steps so as to reduce lead time, and preventing damage to a magnetic head element due to static electricity.

A magnetic head device of the invention includes a magnetic head slider having a magnetic head element and a first electrode and a slider supporter having a second electrode that corresponds to the first electrode. The magnetic head slider is fixed to the slider supporter and the first electrode of the slider and the second electrode of the slider supporter are electrically connected to each other with an anisotropic conductive resin that is liquid in form or highly viscous. In the magnetic head device, it is preferred that a plurality of the first electrodes are formed in a surface of the slider, the surface facing the slider supporter, and a plurality of the second electrodes are formed in a surface of the slider supporter, the surface facing the slider, wherein the electrodes facing one another are electrically connected to one another with the anisotropic conductive resin. It is preferred that at least one pair of the plurality of electrodes of the slider and the slider supporter are electrodes for grounding, the pair of electrodes facing each other.

In the magnetic head device, the magnetic head slider is fixed to the slider supporter and the first electrode of the slider and the second electrode of the slider supporter are electrically connected to each other with the anisotropic conductive resin. Furthermore, damage to the magnetic head element due to static electricity is prevented by providing a plurality of the first and second electrodes, at least one pair of the electrodes being those for grounding.

A method of the invention is provided for manufacturing a magnetic head device including a magnetic head slider having a magnetic head element and a first electrode and a slider supporter having a second electrode that corresponds to the first electrode. The method includes the steps of: applying an anisotropic conductive resin to at least either a surface of the magnetic head element facing the slider supporter or a surface of the slider supporter facing the magnetic head element, and placing the magnetic head element on the slider supporter; and fixing the slider to the slider supporter and electrically connecting the first electrode of the slider and the second electrode of the slider supporter to each other through curing the anisotropic conductive resin.

According to the method, the anisotropic resin allows the slider to be fixed to the slider supporter and the first electrode of the slider and the second electrode of the slider supporter to be electrically connected to each other at the same time. Furthermore, if a plurality of the first and second electrodes are provided, at least one pair of the electrodes being those for grounding, the electrodes for grounding are electrically connected to each other with the anisotropic conductive resin so that grounding for preventing electrostatic damage to the magnetic head device is obtained.

By using an anisotropic resin that is liquid in form or highly viscous, the present invention achieves advantages over magnetic heads manufactured with the use of typical film-type resins. For example, the liquid or highly viscous resin does not require the pre-processing step of precision cutting the resin to ensure that the film matches with the components to be bonded. Further, the film-type resin requires high temperatures (in the neighborhood of 200° C.) to set, for short-time setting in the assembly. On the other hand, the liquid-type or highly viscous resin can tentatively set in the neighborhood of 100 to 150° C. in the assembly. Afterward, the liquid-type or highly viscous resin can set in, for example, an oven. The setting performed in this manner can reduce damage to the device.

Other advantages of the present invention include a reduction in the amount of pressure required to connect components. For example, because the film-type resin has a certain thickness, it requires a relatively large amount of pressure in order for the film to become conductive. Although, the anisotropic resin of this invention may require pressure to a degree, the film-type resin needs more pressure than the anisotropic resin. Accordingly, the extra pressure required by the film-type resin can result in the distortion of the flexure of the suspension. Additionally, because the anisotropic resin requires less pressure, and therefore less distortion of the thickness of the resin, more accurate positioning of the slider can be achieved. Other and further objects, features and advantages of the invention will appear more fully from the following description.

### BRIEF DESCRIPTION OF THE DRAWINGS

FIG. 1 is a perspective view of a magnetic head device of an embodiment of the invention.

FIG. 2 is a cross section taken along line II-II of FIG. 1.

FIG. 3 illustrates a pattern configuration of the magnetic head slider of the magnetic head device shown in FIG. 1.

FIG. 4 illustrates a pattern configuration of the flexure of the magnetic head device shown in FIG. 1.

FIG. 5 is a cross section for illustrating a function of an anisotropic conductive resin used in the magnetic head device shown in FIG. 1.

FIG. 6 is another cross section for illustrating a function of the anisotropic conductive resin.

FIG. 7 is a cross section for illustrating a function of an isotropic conductive resin.

FIG. 8 is a plot for illustrating the relationship between the thickness of the anisotropic conductive resin and the peel strength.

FIG. 9 is a plot for illustrating the relationship between the area where the anisotropic conductive resin is applied and the peel strength.

FIG. 10 is a plot for illustrating the average flying heights of the slider of the magnetic head device shown in FIG. 1 in comparison with those of a related-art slider.

FIG. 11 is a plot for illustrating the dispersions of the flying heights of the slider of the magnetic head device shown in FIG. 1 in comparison with those of the related-art slider.

FIG. 12 is a plot for illustrating the distribution of the flying heights of the slider of the magnetic head device shown in FIG. 1 in comparison with that of the related-art slider.

FIG. 13 is a plot for illustrating the distribution of the flying heights of the slider in comparison with that of the related-art slider.

FIG. 14 is a plot for illustrating the distribution of the flying heights of the slider in comparison with that of the related-art slider.

FIG. 15 is a perspective view of a related-art magnetic head device.

FIG. 16 is a cross section taken along line XV-XV of FIG. 15.

### DETAILED DESCRIPTION OF THE PREFERRED EMBODIMENT

A preferred embodiment of the invention will now be described in detail with reference to the accompanying drawings.

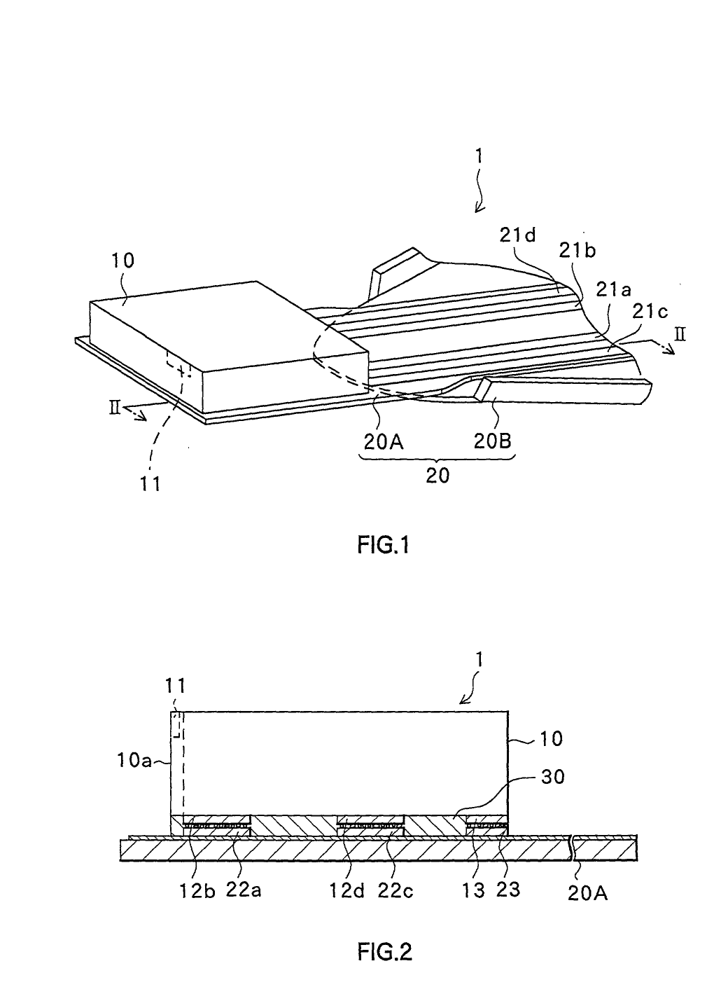

FIG. 1 illustrates a magnetic head device 1 of an embodiment of the invention. FIG. 2 is a cross section taken along line II-II of FIG. 1. The magnetic head device 1 comprises a magnetic head slider 10 bonded to a suspension (slider supporter) 20 with an anisotropic conductive resin 30. The suspension 20 is made up of a flexure (an elastic supporter) 20A and a load beam (a rigid supporter) 20B.

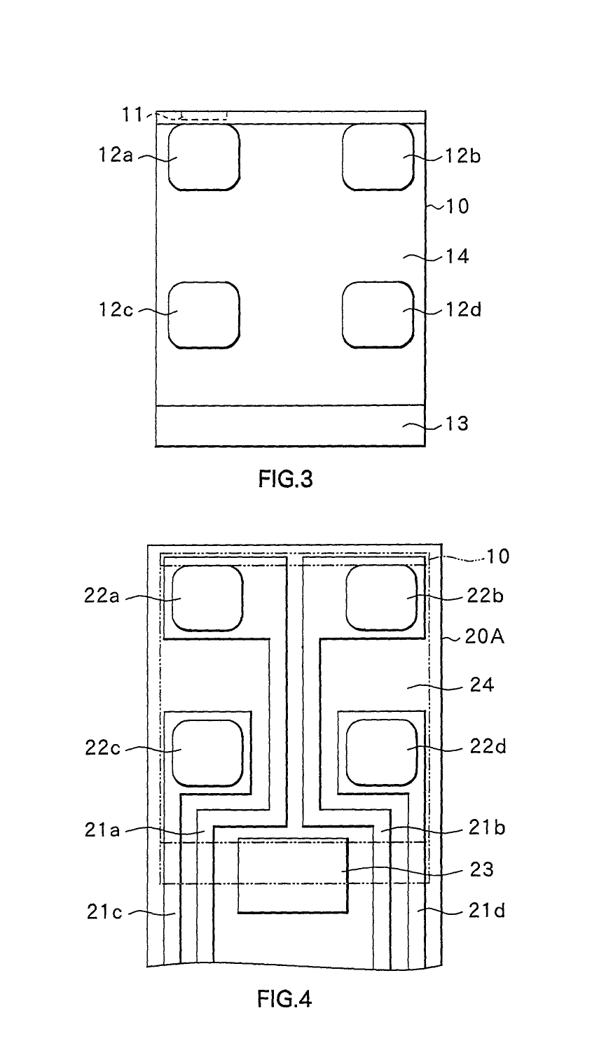

FIG. 3 illustrates the back of the slider 10, that is, a surface 14 facing the flexure 20A. A magnetic head element such as a magnetoresistive (MR) element 11 is formed in the front side surface (an element formed surface 10a) of the slider 10. Electrodes 12a to 12d for signals are formed in the intermediate region of the slider 10. A ground electrode 13 is formed in the rear end of the slider 10. The electrodes 12a to 12d and the electrode 13 each correspond to a first electrode of the invention.

FIG. 4 illustrates a surface 24 of the flexure 20A forming the suspension 20 facing the slider 10. The flexure 20A is made of a stainless steel plate having a thickness of about 25 μm, for example. Four lead patterns 21a to 21d made of thin films of copper (Cu), for example, as input/output signal lines are formed on the surface 24 of the flexure 20A along nearly the entire length thereof. Ends of the lead patterns 21a to 21d are each connected to four electrodes 22a to 22d for signals, made of thin films, respectively. The lead patterns 21a to 21d are each fixed to the electrodes 12a to 12d of the slider 10, respectively. A ground electrode 23 is formed in a position facing the ground electrode 13 of the slider 10. The electrodes 22a to 22d and the electrode 23 each correspond to a second electrode of the invention. The other ends of the lead patterns 21a to 21d are each connected to a connection terminal (not shown) of a thin film of copper (Cu), for example, through which the lead patterns 21a to 21d are connected to external circuitry.

The load beam 20B is made of a stainless steel plate as thick as about 70 μm, for example. The flexure 20A is fixed to the load beam 20B at a plurality of welding spots through laser welding, for example.

The anisotropic conductive resin 30 is made of an adhesive layer in which a conductive filler is dispersed. FIG. 5 is a magnified view of the portion in which the slider 10 and the flexure 20A are bonded to each other with the anisotropic conductive resin 30. In contrast, FIG. 7 illustrates a bonding structure with an isotropic conductive resin generally used, for comparison. In an isotropic conductive resin 40, a conductive filler 42 is mixed in an adhesive layer 41 as much as possible. Conductors 43a and 43b are brought into conduction through contact made among grains of the conductive filler 42.

In contrast to such an isotropic conductive resin, the amount of the conductive filler 32 in the adhesive layer 31 is reduced to as small a volume as possible and the adhesive layer 31 is made thin in the anisotropic conductive resin 30. In the resin 30, conduction is obtained between the signal electrodes 12b and 22a, between the signal electrodes 12d and 22c, and between the ground electrodes 13 and 23 in the direction of thickness through contact among the grains of the conductive filler 32. In the direction of length (the horizontal direction), no conduction is obtained among the electrodes 12a, 12b, 12c and 12d, among the electrodes 22a, 22b, 22c and 22d, between the electrode 13 and the electrodes 12a to 12d, and between the electrode 23 and the electrodes 22a to 22d since there is little contact among the grains of the conductive filler 32.

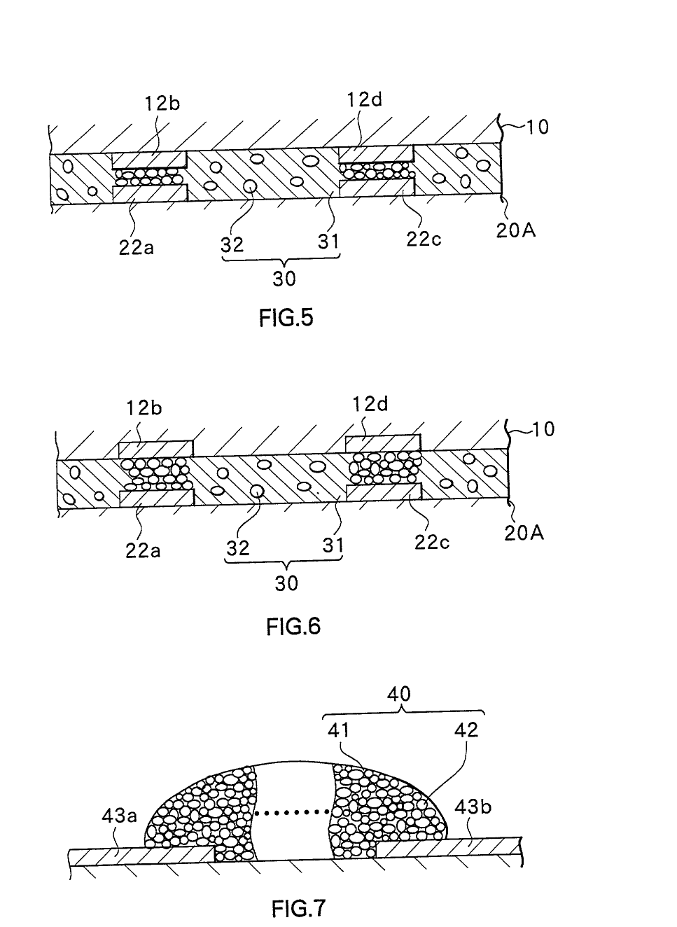

Although in the configuration shown in FIG. 5 each electrode projects from the surfaces of the slider 10 and the flexure 20A, a similar conduction state is obtained with a configuration wherein the electrodes 12a to 12d and the electrode 13 of the slider 10 are embedded and the back of the slider 10 is made flat as shown in FIG. 6.

A material used for the adhesive layer 31 of the anisotropic conductive resin 30 may be a thermosetting resin that may be liquid in form or highly viscous and that cures through an application of ultraviolet rays and heat such as an acrylic resin. The anisotropic conductive resin, when used in assembly can tentatively set in the neighborhood of 100° to 150° C. Afterward, the resin can set in, for example, an oven. Setting the assembly in this manner can reduce the damage to the device. In contrast, anisotropic conductive film requires relatively high temperatures, in the neighborhood of 200° C., for short-time setting in the assembly. The conductive filler 32 may be made of metal grains of silver (Ag), for example, or metal-coated plastic grains, dispersed therein. The average grain diameter of the filler 32 is preferably about 3 μm and the maximum diameter is preferably about 10 μm if the grains are made of silver, for example.

An anisotropic conductive resin made of acrylic in which silver grains are mixed may be made through mixing silver grains, urethane acrylate, and acrylic ester. The liquid-type anisotropic conductive resin cures through an application of ultraviolet rays of 3000 mJ/cm² in total light quantity, for example, under a load of 2.0 kgw/cm², for example, and through an application of heat at 20° C. for 30 minutes, for example.

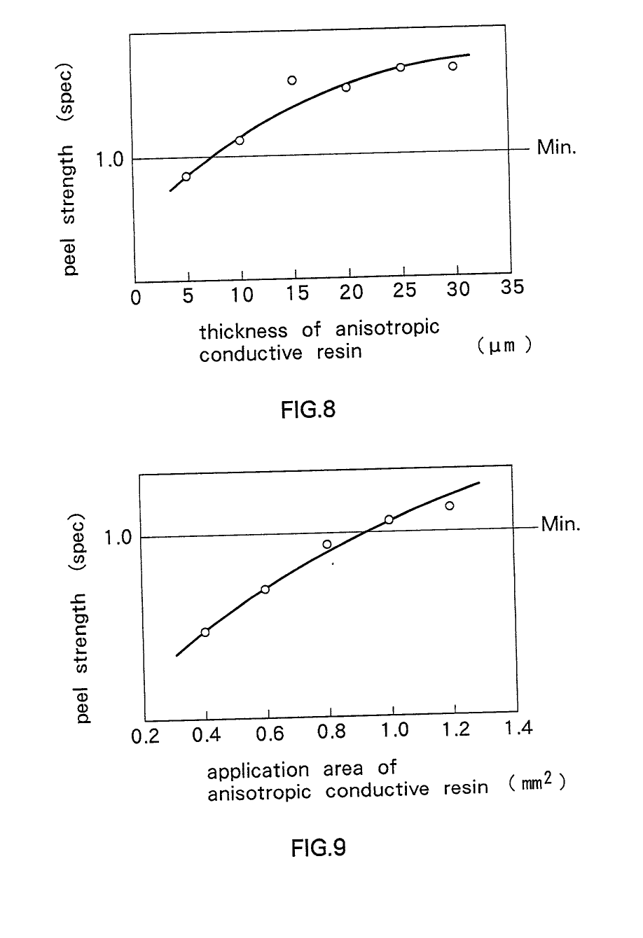

FIG. 8 shows the relationship between the thickness of the anisotropic conductive resin (μm) and the peel strength when the bonding area is constant (1.0 mm²). FIG. 9 shows the relationship between the bonding area (mm²) of the anisotropic conductive resin and the peel strength when the thickness is constant (20 μm). The anisotropic conductive resin used is an acrylic resin wherein silver grains are mixed by about 40 to 60 percent.

The result is that the thickness of the anisotropic conductive resin 30 is preferably 6.0 μm or above to obtain a peel strength of the predetermined specification (1.0) or above when the bonding area is 1.0 mm². Since the conduction resistance could be increased if the resin 30 is too thick, the thickness is preferably 25 μm or below. More preferably, the thickness is equal to or below the maximum grain diameter (10 μm) of silver. Similarly, when the thickness is 20 μm, the area where the anisotropic conductive resin 30 is applied is preferably 0.95 mm² or above.

Generally, the viscosity of the anisotropic resin is between 5 to 500 Pa•s. The tables below shows the relationship between the viscosity of an anisotropic resin, “3373” (manufactured by Three-Bond Co., Ltd.) and its performance. The diameter of the grain used in “3373” is 3 μm.

The results demonstrate that when the viscosity is approximately between 5 Pa•s, the performance in the flow of a resin, such as “3373”, is controllable and visually good.

| Viscosity | | |
|---|---|---|
| Pa's | Visual | Remark |
| 2 | NG | Can not Control |
| 4 | NG | Can not Control |
| 5 | OK | Visual Good |
| 6 | OK | Visual Good |
| 8 | OK | Visual Good |
| 10 | OK | Visual Good |
| 12 | OK | Visual Good |
| 14 | OK | Visual Good |
| 16 | OK | Visual Good |
| 18 | OK | Visual Good |
| 20 | OK | Visual Good |
| . | . | . |
| . | . | . |
| . | . | . |
| 400 | OK | Visual Good |
| 420 | OK | Visual Good |
| 440 | OK | Visual Good |
| 460 | OK | Visual Good |
| 480 | OK | Visual Good |
| 500 | OK | Visual Good |
| 520 | NG | Not Enough Flow |
| 540 | NG | Not Enough Flow |
| 560 | NG | Not Enough Flow |
| 580 | NG | Not Enough Flow |
| 600 | NG | Not Enough Flow |

A method of manufacturing the magnetic head device 1 of the embodiment will now be described.

The anisotropic conductive resin 30 is applied to the surface 24 of the flexure 20A where the signal electrodes 22a to 22d and the ground electrode 23 are formed. The slider 10 is then placed on the anisotropic conductive resin 30 so that the surfaces 24 and 14 face each other. The resin 30 may be applied to the slider 10 or may be applied to both the slider 10 and the flexure 20A. Under a specific load (2.0 kgw/cm², for example), ultraviolet rays are applied to the resin 30 and the resin 30 is further heated at a specific temperature. The resin 30 is thereby cured. As a result, the slider 10 is fixed to the flexure 20A and the signal electrodes 12a to 12d of the slider 10 are each electrically connected to the signal electrodes 22a to 22d of the flexure 20A, respectively. The magnetic head device 1 shown in FIG. 1 is thus formed.

According to the embodiment thus described, simply bonding the slider 10 to the flexure 20A with the anisotropic conductive resin 30 allows the slider 10 to be fixed to the flexure 20A. At the same time, the signal electrodes 12a to 12d of the slider 10 are thereby each electrically connected to the signal electrodes 22a to 22d of the flexure 20A, respectively. Furthermore, the ground electrode 13 provided in the reverse (rear) portion of the magnetic head element 11 of the slider 10 is connected to the ground electrode 23 of the flexure 20A as well. Grounding is thereby provided for preventing damage to the magnetic head element 11 due to static electricity.

In the embodiment, the step of fixing the slider 10 to the flexure 20A and the step of electrically connecting the signal electrodes 12a to 12d and the ground electrode 13 of the slider 10 to the signal electrodes 22a to 22d and the ground electrode 23 of the flexure 20A may be performed in a single step. That is, the steps of (2) and (4) in the related-art manufacturing process described above are no more necessary. The manufacturing process of the magnetic head device 1 is therefore reduced. In addition, since electrical connection is achieved with the liquid-type anisotropic conductive resin 30, gold (Au) that is used in the related-art bonding step is not required. Manufacturing costs are therefore reduced. Since the bonding step is not required, there is no chance that the suspension of the flexure 20A and so on is deformed. The yield of the flying performance is thereby improved.

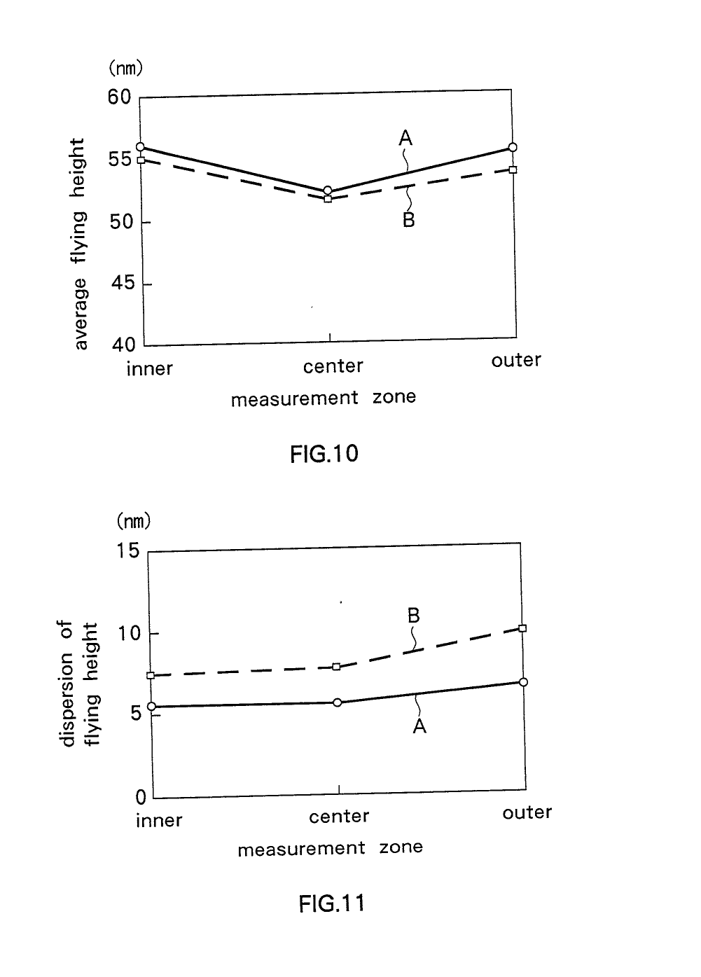

FIG. 10 and FIG. 11 illustrate the flying performance obtained of the magnetic head sliders of the magnetic head device 1 of the embodiment of the invention and a magnetic head device of related art, in comparison with each other. Solid line A indicates the result obtained with the device of the embodiment of the invention. Dotted line B indicates the result obtained with the related-art device. FIG. 10 shows the average flying heights determined in the three zones including the inner, center and outer zones of a magnetic disk. FIG. 11 shows the dispersion of the flying heights in the three zones.

The result is that there is no particularly great difference in the average flying heights (FIG. 10) while the dispersion of the flying height (FIG. 11) of the device of the embodiment is smaller than that of the related art device in the three zones. The result thus indicates that a steady flying performance is obtained.

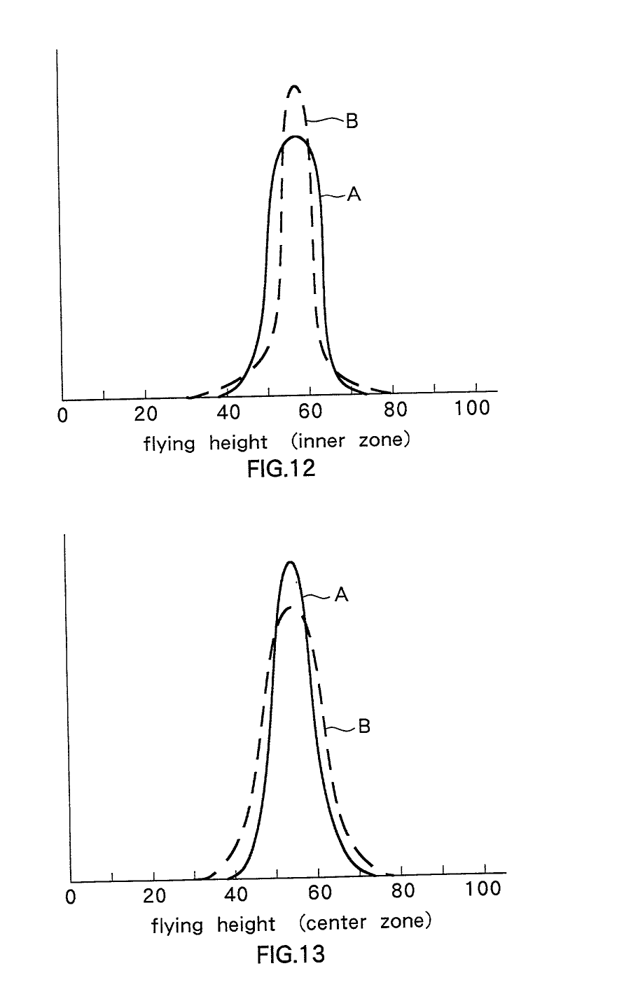

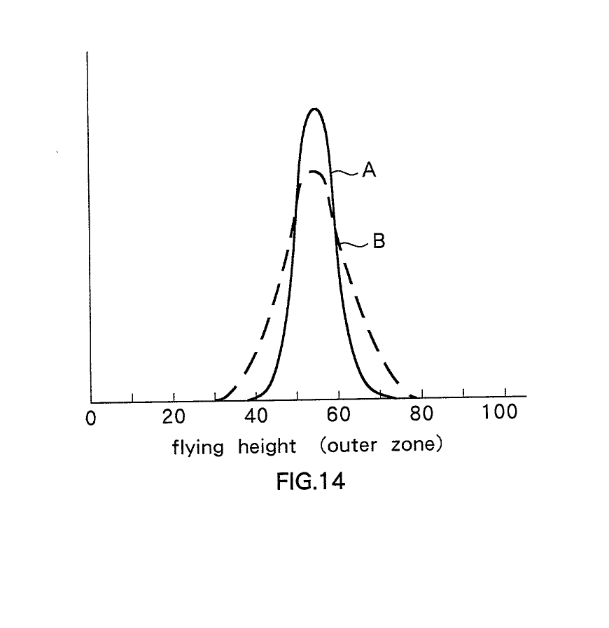

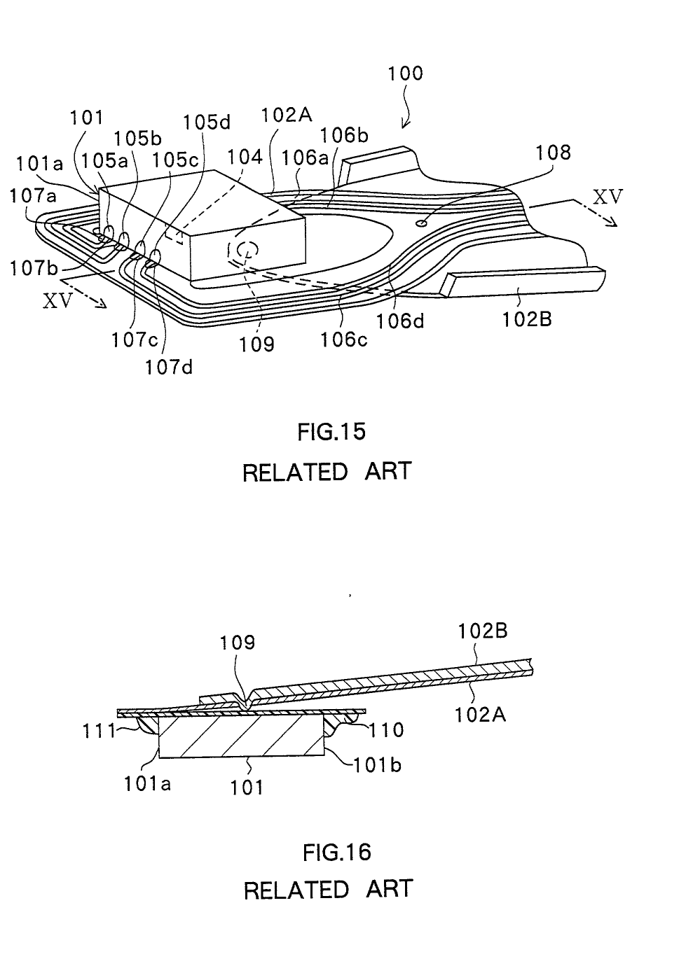

FIG. 12 to FIG. 14 illustrate the flying height distribution in the three measurement zones. FIG. 12 shows the result obtained in the inner zone of the magnetic disk. FIG. 13 shows the result obtained in the center zone. FIG. 14 shows the result obtained in the outer zone. There is a significant dispersion among the zones of dotted line B of the related-art device and the device does not conform to the specification. The yield is thereby reduced. In contrast, the dispersion among the zones of solid line A of the device of the embodiment is small and the device falls within the specification. The device of the embodiment is thus improved, compared to the related-art device.

As thus described, the flying performance of the magnetic head devise 1 of the embodiment is stable, compared to the related-art device, and the yield is improved. Since the ground electrode 13 is provided in the rear portion of the slider 10 which is apart from the magnetic head element 11 formed in the front portion, static electricity is allowed to escape to the flexure 20A without affecting the element 11.

In the embodiment the anisotropic conductive resin is used as a bonding means. As a result, the one bonding step is only required as described above, in contrast to the related-art technique that requires the two bonding steps including preliminary and final bondings wherein the film-shaped anisotropic conductive sheet is used. Consequently, the lead time is reduced compared to the case wherein the related-art anisotropic conductive sheet is used.

In contrast to the anisotropic conductive film, the anisotropic resin needs less pressure to become conductive. The anisotropic conductive film has a certain thickness, such that it needs pressure to become conductive. Because the use of the anisotropic conductive film requires more pressure than the anisotropic resin, there is danger involved in assembly of the magnetic head device because the flexure of the suspension may become distorted.

The present invention is not limited to the foregoing embodiment but may be practiced in still other ways. In the foregoing embodiment, for example, the conductive resin 30 is applied to the entire surface of the flexure 20A that faces the slider 10 and the flexure 20A and the slider 10 are brought to contact with each other at the entire surfaces. Alternatively, the slider 10 and the flexure 20A may be bonded to each other with a sufficient strength through applying the conductive resin 30 to the electrode portions only, depending on the sizes of the electrodes 12a to 12d and 22a to 22d arid so on. The structure of the suspension 20 as the slider supporter is not limited to the one illustrated in the foregoing embodiment but may be any other one.

According to the magnetic head device of the invention thus described, the magnetic head slider is fixed to the slider supporter and the first electrode of the slider and the second electrode of the slider supporter are electrically connected to each other with the anisotropic conductive resin. As a result, the yield of flying performance of the slider is improved and the manufacturing steps thereof are simplified so as to reduce the lead time.

In the magnetic head device a plurality of the first and second electrodes may be provided and at least one pair of the electrodes may be electrodes for grounding. Damage to the magnetic head element due to static electricity is thereby prevented.

According to the method of manufacturing a magnetic head device of the invention, an anisotropic conductive resin is cured so that the magnetic head slider is fixed to the slider supporter and the first electrode of the slider and the second electrode of the slider supporter are electrically connected to each other. As a result, the magnetic head device whose flying performance is improved is manufactured through simplified steps and the lead time is reduced.

Obviously many modifications and variations of the present invention are possible in the light of the above teachings. It is therefore to be understood that within the scope of the appended claims the invention may be practiced otherwise than as specifically described.

What is claimed is:

1. A magnetic head device including a magnetic head slider having a magnetic head element and a first electrode and a slider supporter having a second electrode that corresponds to the first electrode, wherein:
the magnetic head slider is fixed to the slider supporter and the first electrode of the slider and the second electrode of the slider supporter are electrically connected to each other with an anisotropic conductive resin.

2. The magnetic head device according to claim 1 including a plurality of the first electrodes formed in a surface of the slider, the surface facing the slider supporter, and a plurality of the second electrodes formed in a surface of the slider supporter, the surface facing the slider, wherein the electrodes facing one another are electrically connected to one another with the anisotropic conductive resin.

3. The magnetic head device according to claim 2 wherein at least one pair of the plurality of electrodes of the slider and the slider supporter are electrodes for grounding, the pair of electrodes facing each other.

4. The magnetic head device according to claim 3 wherein the magnetic head element is provided at an end portion of the slider and the electrode for grounding is provided in the other end portion of the slider.

5. The magnetic head device according to claim 1 wherein the magnetic head element is a magnetoresistive head element.

6. The magnetic head device according to claim 1 wherein the anisotropic conductive resin includes an adhesive layer including a conductive filler.

7. The magnetic head device according to claim 1 wherein the adhesive layer of the anisotropic conductive resin is a thermosetting resin.

8. The magnetic head device according to claim 7 wherein the thermosetting resin is an acrylic resin.

9. The magnetic head device according to claim 6 wherein the conductive filler is a silver powder.

10. A method of manufacturing a magnetic head device including a magnetic head slider having a magnetic head element and a first electrode and a slider supporter having a second electrode that corresponds to the first electrode, comprising applying an anisotropic conductive resin to at least either a surface of the magnetic head element facing the slider supporter or a surface of the slider supporter facing the magnetic head element, and placing the magnetic head element on the slider supporter; and fixing the slider to the slider supporter and electrically connecting the first electrode of the slider and the second electrode of the slider supporter to each other through curing the anisotropic conductive resin.

11. The method according to claim 10, further including: providing a plurality of the first electrodes in the surface of the slider facing the slider supporter, and a plurality of the second electrodes in the surface of the slider supporter facing the slider, and electrically connecting the electrodes facing one another to one another with the anisotropic conductive resin.

12. A magnetic head device including a magnetic head slider having a magnetic head element and a first electrode with a planar surface and a slider supporter having a second electrode with a planar surface that corresponds to the first electrode, wherein:
the magnetic head slider is fixed to the slider supporter and the first electrode of the slider and the second electrode of the slider supporter are electrically connected to each other with a liquid-type anisotropic conductive resin.

13. A magnetic head device including a magnetic head slider having a magnetic head element and a first electrode and a slider supporter having a second electrode that corresponds to the first electrode, wherein:
the magnetic head slider is fixed on the slider supporter, and the first electrode of the magnetic head slider and the second electrode of the slider supporter are electrically connected, by using a liquid-type anisotropic conductive resin and by applying pressure.

14. A magnetic head device including a magnetic head slider having a magnetic head element and a first electrode and the first electrode is formed on a different surface from the surface on which the magnetic head element is formed, and a slider supporter having a second electrode that corresponds to the first electrode, wherein:
the magnetic head slider is fixed to the slider supporter and the first electrode of the slider and the second electrode of the slider supporter are electrically connected to each other with a liquid-type anisotropic conductive resin.

15. The magnetic head device according to claim 14, wherein the first electrode is formed on a magnetic head slider.

16. The magnetic head device according to claim 1, wherein the viscosity of the anisotropic resin is approximately between 5 to 500 Pa•s.

17. The method according to claim 10, wherein the viscosity of the anisotropic resin is approximately between 5 to 500 Pa•s.

18. The magnetic head device according to claim 12, wherein the viscosity of the liquid-type anisotropic resin is approximately between 5 to 500 Pa•s.

19. The magnetic head device according to claim 13, wherein the viscosity of the liquid-type anisotropic resin is approximately between 5 to 500 Pa•s.

20. The magnetic head device according to claim 14, wherein the viscosity of the liquid-type anisotropic resin is approximately between 5 to 500 Pa•s.
